(19) United States
(12) Patent Application Publication
(10) Pub. No.: US 2022/0133127 A1
(43) Pub. Date: May 5, 2022

(54) After Treatment System Comprising a Cleaning Device, an Impregnation Device and Refilling Means

(71) Applicant: Imbox Shoecare A/S,, Egå (DK)

(72) Inventor: René Marker, Auning (DK)

(21) Appl. No.: 17/435,740

(22) PCT Filed: Mar. 5, 2020
(86) PCT No.: PCT/DK2020/050059

§ 371 Date: Sep. 2, 2021

(30) Foreign Application Priority Data
Mar. 6, 2019 (DK) PA 2019 70154

(51) Int. Cl. A47L 23/05; A43D 95/06; B05C 1/02; B05C 11/10

(52) U.S. Cl. CPC A47L 23/05; B05C 11/10; B05C 1/02; A43D 95/06

(57) ABSTRACT

After treatment system for re-applying an impregnation treatment onto a previously treated item such as a shoe, glove, handbag, coat or the like, where said after treatment system comprises: A cleaning device having a body and integrating or having access to a reservoir containing a cleaning liquid, said reservoir being in connection with an application surface; An impregnating device having a body integrating or having access to a reservoir containing an impregnating balm, said reservoir being in connection with an application surface, where both reservoirs comprise means for refilling said reservoirs, and where the application surface is inter-changeable with another application surface.

This application claims the benefit of Danish Application No. PA 2019 70154 filed Mar. 6, 2019 and PCT/DK2020/050059 filed Mar. 5, 2020, International Publication No. WO 2020/177828 A1, which are hereby incorporated by reference in their entirety as if fully set forth herein.

### FIELD OF THE INVENTION

The present invention relates to an after treatment system for reapplying an impregnation treatment onto a previously treated item.

### BACKGROUND OF THE INVENTION

It is a common occurrence, particularly in Northern and wet climates, to impregnate shoes, overcoats and the like in order to make them more resistant to particularly water. At least within the present invention this type of impregnation shall be understood as a waterproofing process where an agent is applied to a surface in order to either render the surface waterproof or improve or re-establish the surface's water repellent properties.

This is for example done by manually spraying an impregnating agent onto the object being a show, glove, handbag or coat or by means of an automatic spraying booth, as for example disclosed in the same applicant's prior patent EP2964051.

An example of a device suitable to dispense a liquid from a hollow handle is known from US 2016/0000213. In a hollow handle a liquid to be dispensed is stored. The hollow interior is in liquid communication with a dispensing head, which head comprises a sponge. In this manner the liquid may be provided on the sponge, and by applying the sponge to an object the liquid may be applied to the object.

A somewhat similar device is known from CN 2045264 wherein a shoe brush is disclosed. The device comprises a brush head in liquid connection to a reservoir. It is possible to exchange the brush head and refill the liquid reservoir, when the brush head is removed. A similar device is disclosed in US2013/0047358.

A further example of an application device is disclosed in WO00/28873. This device is particular in that it contains two reservoirs which are in communication with an application sponge. It is the intention that two liquids are arranged in separate reservoirs and during application are mixed such that the device makes it possible to apply a two-component treatment by using only one handheld device, and that the liquids are mixed as they are needed during application. A refilling station is provided where both reservoirs may be refilled with the components making up the two-component treatment.

One problem with these treatments is that the treatment as such deteriorates over time both as a function of wear and tear and/or just by aging. In some instances the initial treatment was not sufficient to render the item/object treated sufficiently water repellent or waterproof. In such instances the treatment shall be renewed or completed in order to achieve the desired effect, i.e. re-establish the water repellent/waterproofing properties.

For most users a reapplication only occurs very seldom and as such the initial treatment is rendered useless after a few weeks or months in that reapplication requires purchase of additional impregnating agent or retreatment in the device mentioned above.

### OBJECT OF THE INVENTION

Consequently, it is an object of the present invention to provide an after-treatment system which encourages and makes it easy for the user to reapply the treatment and furthermore ensures that the renewed treatment is of the same basic constituents as the original treatment in order to obtain an improved effect.

### DESCRIPTION OF THE INVENTION

The invention addresses this by providing an after treatment system for re-applying an impregnation treatment onto a previously treated item such as a shoe, glove, handbag, coat or the like, where said after treatment system comprises:
A cleaning device having a body and integrating or having access to a reservoir containing a cleaning liquid, said reservoir being in connection with an application surface;
An impregnating device having a body integrating or having access to a reservoir containing an impregnating balm, said reservoir being in connection with an application surface,
   where both reservoirs comprise means for refilling said reservoirs, and where the application surface is inter-changeable with another application surface, and that the reservoirs of the cleaning device and the impregnating device each are provided with one-way valves, and where the reservoirs may be refilled by connecting the one-way valves to sources of impregnating balm and cleaning liquid respectively.

The provision of an after treatment system both including a cleaning device and an impregnating device makes it handy and easy to carry out the required treatment. Naturally the cleaning device will contain the necessary devices in order to clean the surface of the item to be treated, but furthermore it will also apply a cleaning liquid which is suitable for the purpose.

Often cleaning liquids of the more normal household brands will be used prior to reapplying in the normal fashion, and these household cleaning liquids will typically contain compounds which are detrimental to the impregnating agent or to the surface of the item to be treated.

Furthermore, as the same constituents of the originally used impregnating agent is comprised in the impregnating balm used for reapplication of the impregnating agent it is ensured that a homogenous and cohesive impregnating procedure is achieved in that the two materials are compatible.

In order for the after treatment system to be suitable to handle the reapplication of the impregnating agent the impregnating agent is in the shape of an impregnating balm. In this connection the balm shall be understood as an impregnating agent having a consistency or viscosity as a thick flowing oil or cream.

The one-way valves are provided in order to be able to refill the cleaning device and impregnating device such that these devices may be reusable. This provides the added advantage that it is possible to manufacture the cleaning device and impregnating device at a higher standard and thereby at a higher cost in that the life expectancy of the devices may be designed to be substantially longer than if they had been for a single use only. This also allows the provision of a quality which provides an added benefit to the user.

Furthermore, the environmental impact of the after treatment system is substantially minimized in that all items are reusable, except, of course, the cleaning liquid and the impregnating balm.

In a still further advantageous embodiment of the invention the application surfaces of one or both the cleaning device and impregnating device are resilient and/or soft sponge.

Particularly for certain items it is important that the cleaning device and impregnating device do not have any hard surfaces or hard edges in that they may scratch the item to be impregnated and furthermore it is desirable to have a very resilient surface such that the surface may deform to the contours of the items to be impregnated. In cases where the surfaces are in the shape of a soft sponge it is also possible to allow the impregnating balm to be provided in a relatively thick, but smooth layer on the item which is to be treated.

In a still further advantageous embodiment of the invention the reservoirs each are provided with a permeable and resilient surface such that when the cleaning device and/or the impregnating device is forced against the permeable and resilient surface, cleaning liquid or impregnating balm is transferred to the respective application surfaces.

In this manner the user has full control of the application speed and amount of cleaning liquid or impregnating balm respectively, simply by urging the impregnating device or the cleaning device against the surface to be treated. As the pressure caused by urging the device against the surface increases, cleaning liquid or impregnating balm will be squeezed out through the permeable surface and as such be transferred to the object to be treated.

In a still further advantageous embodiment of the invention the cleaning device and/or the impregnating device is provided with a resilient body portion or a button device, such that when the resilient body portion is deformed or the button device activated, the reservoir volume is affected.

This is an alternative manner in which to achieve the object already mentioned above with respect to the embodiment where the devices are provided with a resilient surface, but in this embodiment the devices are provided with a resilient body or a bottom such that by depressing the bottom the volume for example containing the impregnating balm or cleaning liquid will be under pressure whereby the balm/liquid will be forced towards the surface of the object to be treated.

In a still further advantageous embodiment of the invention a refill station containing the reservoir containing cleaning liquid, and the reservoir containing impregnating balm, is integrated in a impregnating apparatus, said impregnating apparatus comprising a closed treatment chamber in which chamber one or more nozzles are provided for injecting a mist of impregnating liquid towards an item to be treated, and where the active ingredients in the impregnating agent used for treating the item in the apparatus is the same as the active ingredient in the impregnating balm, and where the refill station of said impregnating apparatus comprises a docking station for direct or indirect connection to the cleaning device and the impregnating device.

The apparatus may for example be the apparatus as already mentioned above with reference to the applicant's prior European patent EP2964051 where additionally a docking station is provided such that the cleaning device and impregnating device may be attached for example by the one way valves or by other means to the reservoirs of impregnating balm and cleaning liquid. This embodiment is particularly advantageous in that it will probably be the same service organization and supplier providing the impregnating agent for the apparatus as the impregnating balm used with the after treatment system according to the present invention such that the main ingredients or active ingredients of particularly the impregnating agent/balm is the same such that it is ensured that the after treatment impregnating routine is compatible with the originally performed impregnating routine. Furthermore, it is also ensured that approved cleaning agents are dispensed from the cleaning device.

In a still further advantageous embodiment the after treatment system as described above where it comprises a refill station integrated into an impregnating apparatus may in a further advantageous embodiment be distinguished in that the cleaning device and impregnating device are provided with a common housing, such that the cleaning device and the impregnating device may be removed from the housing and reinserted, where the housing optionally comprises reservoirs for storing cleaning liquid and impregnating balm, and where means are provided for refilling the cleaning liquid and impregnating balm to the cleaning device and the impregnating device respectively, and means for refilling the reservoirs with cleaning liquid and impregnating balm respectively, where said housing is connectable to the refill station, such that the reservoirs in the housing may be replenished.

With this configuration it is possible for a user to carry the housing to a location where an impregnating apparatus comprising a refill station is placed. This will often be in a shoe shop or department store. Here it will either be possible to exchange the housing for a new refilled device, i.e. where the reservoirs of the cleaning device and impregnating device have been refilled or where the reservoirs in the housing have been refilled such that a number of application may be carried out in the future away from the impregnating apparatus.

This combination of features really distinguishes the present invention and its concept from the traditional use of spray cans in that it provides a reusable system which has a negligible environmental impact and at the same time makes it extremely convenient for the user to be sure to use the right materials when cleaning a re-treating items such as shoes, handbags and the like.

### DESCRIPTION OF THE DRAWING

The invention will now be explained with reference to the accompanying drawings wherein

FIG. 1 illustrates a cleaning device and an impregnating device

FIG. 2 illustrates a refill station provided with two docking stations

FIG. 3 illustrates a device where the body of the device is provided with a soft section

FIG. 4 illustrates a further embodiment where a bottom is used to pressurize the internal reservoir

FIG. 5 illustrates an apparatus, for example as disclosed in the same applicant's prior patent EP2964051

FIG. 6 illustrates a housing

### DETAILED DESCRIPTION OF THE INVENTION

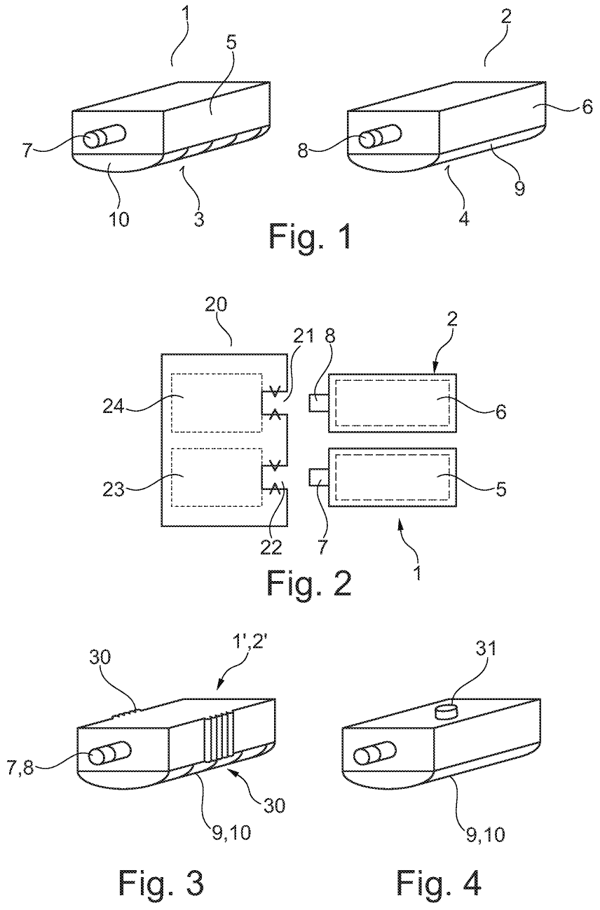

In FIG. 1 is schematically illustrated a cleaning device 1 and an impregnating device 2. In the illustrated embodiment both the cleaning device and the impregnating device 2 are illustrated as rectangular closed boxes each with an under-surface 3, 4 suitable to apply cleaning liquid and impregnating balm respectively.

The shape may of course vary considerably, but in order to disclose the concept of the present invention reference will be made to the cleaning device and impregnating device as illustrated with reference to FIG. 1. It should, however, be understood that the devices may have any suitable and desirable shape such as oval, square, round, spherical and so on. The devices 1, 2 are provided with internal reservoirs 5, 6 indicated by the dashed lines.

In order to refill the reservoirs 5, 6 both devices 1, 2 are provided with means for refilling the reservoirs 5, 6 where the means in this embodiment is illustrated by extending connection valves 7, 8. By connecting the valves 7, 8 to respective reservoirs containing cleaning liquid and impregnating balm it is possible to refill the reservoirs 5, 6.

Both devices 1, 2 are provided with application surfaces 9, 10 where the application surfaces typically will vary. For the cleaning device 1 the application surface 10 shall have a surface suitable to remove dust and debris from the object to be treated and at the same time be permeable to such an extent that the cleaning liquid contained in the reservoir 5 may seep into the application member 10 and thereby to the application surface of the application member in an amount sufficiently to thoroughly clean the surface, but also limited to an amount so that it will not spill or drip from the application surface 10. As the viscosity between the cleaning liquid and the impregnating balm is different, the application surface 9 of the impregnating device 2 will have a different character. Typically, the impregnating balm will have a higher viscosity comparable to a thick oil or soft cream and as such the balm will be less likely to drip and spill from the application surface 9.

For this purpose it is necessary to ensure that the flow of balm from the reservoir to the application surface is sufficient and that the application of balm from the application surface 9 to the object to be treated is such that a sufficient layer of impregnating agent will be transferred to the object to be treated.

In FIG. 2 is schematically illustrated a refill station 20 provided with two docking stations 21, 22. The docking stations are designed to receive and accommodate the valves 7, 8 of the devices 1, 2 such that when the valves 7, 8 are inserted into the docking stations 21, 22 it will be possible to have liquid communication between the reservoirs 5, 6 of the devices 1, 2 and somewhat larger reservoirs 23, 24 in the refill station. It is clear that the reservoir 24 shall be provided with impregnating balm such that the reservoir 6 of the impregnating device 2 is refilled with the appropriate liquid and vice versa with respect to the cleaning device 1, it shall be connectable to the reservoir 23 containing the cleaning liquid.

In order to make this fool proof the connection valves 7, 8 may have different dimensions or shapes such that it is only possible to insert the correct device 1, 2 in the correct docking station 21, 22. The liquids contained in the reservoirs 23, 24 of the refill station 20 may be under pressure such that as the valves 7, 8 are inserted into the docking station 21, 22 liquid will flow from the reservoirs 23, 24 of the docking station 20 into the reservoirs 5, 6 of the cleaning device and impregnating device 1, 2 respectively.

It is also foreseen that the reservoirs 23, 24 are dimensioned such that the cleaning liquid and the impregnating balm will be provided in batch sizes such that as the cleaning device and impregnating device 1, 2 are inserted into the docking station 21, 22 only the correct amount of cleaning liquid and impregnating agent respectively will be transferred from the reservoirs 23, 24 of the refill station 20 into the devices 1, 2. With the devices as illustrated and described with reference to FIG. 1 it is foreseen that application of cleaning liquid and impregnating balm is created by urging the device 1, 2 against the surface to be impregnated whereby the application surfaces 9, 10 will release sufficient cleaning liquid or impregnating balm in order to carry out the process sufficiently.

In other instances the device may be provided with means for issuing a determined amount of cleaning agent or impregnating agent. For example, in FIG. 3 is illustrated a device 1′ where the body of the device is provided with a soft section 30 such that the device may be deformed. In this context it should mentioned that the soft section may have many shapes and constructions, but for illustrative purposes it is only illustrated as a soft section in a central part of the device 1′, 2′. By deforming the soft sections 30 the internal reservoirs 5, 6 will be squeezed whereby a cleaning liquid or impregnating balm is transferred to the application surface 9, 10 such that correct cleaning and impregnating may be instigated.

In FIG. 4 is illustrated a further embodiment where a bottom 31 is used to pressurize the internal reservoir whereby cleaning liquid or impregnating balm may be transferred to the application surface 9, 10.

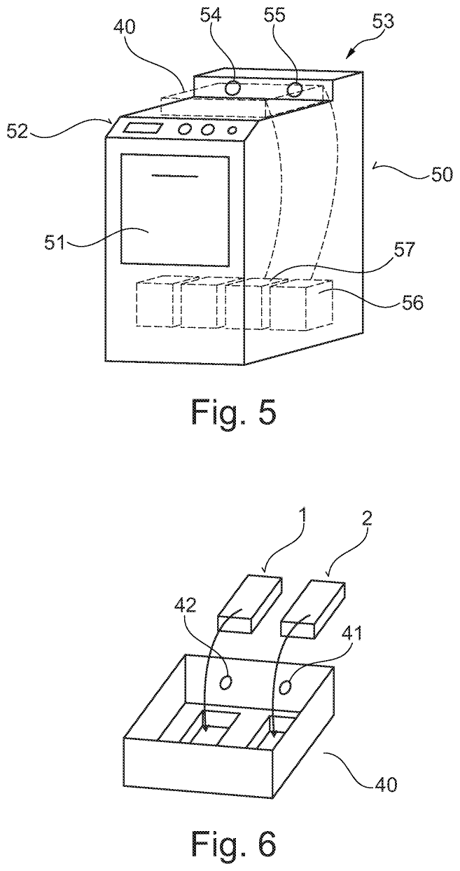

In FIGS. 5 and 6 are schematically illustrated a system where the cleaning device 1 and the impregnating device 2 is provided with a housing 40. The devices 1, 2 may be inserted into the housing 40 and be connected by docking means 41, 42 either to reservoirs incorporated in the housing 40 (which are not illustrated), or where the docking stations 41, 42 on an outside face of the housing 40 may be connected to external reservoirs.

In FIG. 5 is illustrated an apparatus, for example as disclosed in the same applicant's prior patent EP2964051. The apparatus 50 incorporates a treatment chamber which is accessible through an openable door 51 where items to be treated may be placed in the treatment chamber after which the door 51 is closed. The inner parts of the device 50 comprises nozzles for ejecting a mist of impregnating agent towards the items to be impregnated as well as evacuation means for evacuating any surplus impregnating mist such that as the door is reopened after treatment such impregnating mist is not released to the ambient environment. The device 50 is further provided with a control panel 52 such that appropriate routines for operating the device 50 may be selected.

In this embodiment the device 50 is furthermore provided with a docking station 53 such that a housing as explained with reference to FIG. 6 may be positioned and connected to the valves 54, 55. In this manner the devices 1, 2 positioned inside the housing 40 as explained above will be in liquid communication through the valves 54, 55 to reservoirs 56, 57 indicated by dashed lines inside the device 50.

As it will typically be the same personnel servicing the apparatus 50 that will supply the correct impregnating liquids to the device 50, it is foreseen that as the impregnating agent will be based on the same constituents as the impregnating balm used with the present invention in order to ensure that the after treatment will be compatible with the original treatment it is a great assurance that the same personnel will replace and refill the reservoirs, such that the liquids and balm are supplied from the same source with impregnating liquid and impregnating balm such that the compatibility of the after treatment system is ensured.

Furthermore, as the same distributor delivering the liquids to the device 50 also will be delivering the cleaning liquid for use with the after treatment system it is ensured that a cleaning liquid compatible with the impregnating liquid and balm will be supplied also to the after treatment system according to the present invention.

1. After treatment system for re-applying an impregnation treatment onto a previously treated item such as a shoe, glove, handbag, coat or the like, where said after treatment system comprises:
A cleaning device (1) having a body and integrating or having access to a reservoir (5) containing a cleaning liquid, said reservoir (5) being in connection with an application surface (9);
An impregnating device (2) having a body integrating or having access to a reservoir (6) containing an impregnating balm, said reservoir (6) being in connection with an application surface (10),
where both reservoirs (5,6) comprise means (7,8) for refilling said reservoirs (5,6), and where the application surface (9,10) is inter-changeable with another application surface, and further that the reservoirs (5,6) of the cleaning device (1) and the impregnating device (2) each are provided with one-way valves (7,8), and where the reservoirs (5,6) may be refilled by connecting the one-way valves (7,8) to sources of impregnating balm and cleaning liquid respectively.

2. After treatment system according to claim 1, wherein the application surfaces (9,10) of one or both the cleaning device (1) and impregnating device (2) are resilient and/or soft sponge.

3. After treatment system according to claim 1, wherein the reservoirs (5,6) each are provided with a permeable and resilient surface such that when the cleaning device (1) and/or the impregnating device (2) is forced against the permeable and resilient surface, cleaning liquid or impregnating balm is transferred to the respective application surfaces (9,10).

4. After treatment system according to claim 1, wherein the cleaning device (1) and/or the impregnating device (2) is provided with a resilient body portion (30) or a button device (31), such that when the resilient body portion (30) is deformed or the button device (31) activated, the reservoir volume is affected.

5. After treatment system according to claim 1, wherein a refill station (53) containing a reservoir (56) containing cleaning liquid, and a reservoir (57) containing impregnating balm, is integrated in a impregnating apparatus (50), said impregnating apparatus (50) comprising a closed treatment chamber in which chamber one or more nozzles are provided for injecting a mist of impregnating liquid towards an item to be treated, and where the active ingredients in the impregnating agent used for treating the item in the apparatus is the same as the active ingredient in the impregnating balm, and where the refill station of said impregnating apparatus (50) comprises a docking station (53) for direct or indirect connection to the cleaning device (1) and the impregnating device (2).

6. After treatment system according to claim 5, wherein the cleaning device (1) and impregnating device (2) are provided with a common housing (40), such that the cleaning device (1) and the impregnating device (2) may be removed from the housing (40) and reinserted, where the housing (40) optionally comprises reservoirs for storing cleaning liquid and impregnating balm, and where means (41,42) are provided for refilling the cleaning liquid and impregnating balm to the cleaning device (1) and the impregnating device (2) respectively, and means for refilling the reservoirs with cleaning liquid and impregnating balm respectively, where said housing (40) is connectable to the refill station (53), such that the reservoirs in the housing may be replenished.
